(19) United States
(12) Patent Application Publication
(10) Pub. No.: US 2016/0212090 A1
(43) Pub. Date: Jul. 21, 2016

(54) SYSTEM AND METHOD FOR TRACKING CONVERSATIONS

(71) Applicant: General Electric Company, Schenectady, NY (US)

(72) Inventors: Atul Chandrakant Kshirsagar, San Ramon, CA (US); Sriramakrishna Yelisetti, San Ramon, CA (US); Veera Kishore Reddipalli, San Ramon, CA (US); Dave Xiao Feng Chen, San Ramon, CA (US)

(21) Appl. No.: 14/598,677

(22) Filed: Jan. 16, 2015

(51) Int. Cl. H04L 12/58

(52) U.S. Cl. CPC H04L 51/34; H04L 51/16; H04L 51/046

(57) ABSTRACT

A system and method for tracking conversations is disclosed. The method includes receiving an alert, the alert comprising operation information of a machine, determining a user for the alert, determining a first communication medium for a notification message, transmitting the notification message to the user via the first communication medium, the notification message comprising the operation information, storing a record of the notification message in a database in association with a conversation identification, receiving a command message from the user via a second communication medium different from the first communication medium, the command message comprising an instructional command for the machine, transmitting the command message to a control unit of the machine, the control unit being configured to control an operation of the machine based on the instructional command, and storing a record of the command message in the database in association with the conversation identification.

### TECHNICAL FIELD

The present application relates generally to the technical field of data processing, and, in various embodiments, to a system and method for tracking conversations between machines and humans across multiple mediums.

### BACKGROUND

Traditional two-way communication, between humans or between humans and machine, is restricted to being carried over only one type of communication medium and cannot be carried over a communication medium other than the originating communication medium (e.g., the communication medium used for the initial message of the conversation). This approach limits how the conversation can be conducted, especially for people who are on the go and may or may not have access to the medium of communication with which the conversation first started. The medium of communication can be constrained based on the bandwidth or type of device or location of the user.

### BRIEF DESCRIPTION

Some or all of the above needs or problems may be addressed by one or more example embodiments. Example embodiments of a system and method for selective gesture interaction using spatial volumes are disclosed.

In one example embodiment, a computer-implemented method comprises receiving an alert, the alert comprising operation information of a machine, determining a user for the alert, determining a first communication medium for a notification message, transmitting the notification message to the user via the first communication medium, the notification message comprising the operation information, storing a record of the notification message in a database in association with a conversation identification, receiving a command message from the user via a second communication medium different from the first communication medium, the command message comprising an instructional command for the machine, transmitting the command message to a control unit of the machine, the control unit being configured to control an operation of the machine based on the instructional command, and storing a record of the command message in the database in association with the conversation identification.

The above and other features, including various novel details of implementation and combination of events, will now be more particularly described with reference to the accompanying figures and pointed out in the claims. It will be understood that the particular techniques, methods, and other features described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a network diagram illustrating a client-server system, in accordance with some example embodiments;

FIG. 2 is a block diagram illustrating components of a conversation tracking system, in accordance with some example embodiments;

FIG. 3 illustrates a user interface displaying a conversation, in accordance with some example embodiments;

FIG. 4 illustrates a user interface displaying a conversation, in accordance with some example embodiments;

FIG. 5 illustrates a notification message, in accordance with some example embodiments;

FIG. 6 illustrates a command message, in accordance with some embodiments;

FIG. 7 is a flowchart illustrating a method, in accordance with some example embodiments, for tracking conversations;

FIG. 8 is a flowchart illustrating a method, in accordance with some example embodiments, for determining a communication medium and transmitting a notification message;

FIG. 9 is a block diagram illustrating a mobile device, in accordance with some example embodiments; and

FIG. 10 is a block diagram of an example computer system on which methodologies described herein can be executed, in accordance with some example embodiments.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Example systems and methods of tracking conversations between machines and humans across multiple mediums are disclosed. In the following description, for purposes of explanation, numerous specific details are set forth in order to provide a thorough understanding of example embodiments. It will be evident, however, to one skilled in the art that the present embodiments can be practiced without these specific details.

In some example embodiments, an alert is received, with the alert comprising operation information of a machine. A user is determined for the alert. A first communication medium is determined for a notification message. The notification message is transmitted to the user via the first communication medium, with the notification message comprising the operation information. A record of the notification message is stored in a database in association with a conversation identification. A command message is received from the user via a second communication medium different from the first communication medium, with the command message comprising an instructional command for the machine. The command message is transmitted to a control unit of the machine, with the control unit being configured to control an operation of the machine based on the instructional command. A record of the command message is stored in the database in association with the conversation identification.

In some example embodiments, the machine comprises an industrial machine. In some example embodiments, the operation information comprises at least one of an indication of a malfunction and diagnostic data. In some example embodiments, the instructional command comprises at least one of a command to perform a diagnostic operation on the machine, a command to disable a function of the machine, and a command to adjust a configuration parameter of the machine. In some example embodiments, the first communication medium and the second communication medium each comprise one of e-mail messaging, text messaging, Hypertext Transfer Protocol (HTTP) POST messaging, instant messaging, and Voice over IP (VoIP) messaging.

In some example embodiments, determining the first communication medium further comprises determining a plurality of communication mediums corresponding to the user, with the plurality of communication mediums including the first communication medium, and transmitting the notification message further comprises transmitting the notification message via the plurality of communication mediums.

In some example embodiments, determining the first communication medium further comprises selecting the first communication medium from amongst a plurality of communication mediums based on at least one of profile information of the user, time-based information corresponding to the notification message, the operation information, an identification of the industrial machine, a capability measurement for at least one of the plurality of communication mediums, a type of device corresponding to the user, and a detected location of the user.

In some example embodiments, a visual representation of the notification message and a visual representation of the command message are caused to be displayed concurrently in association with the conversation identification within a user interface on a computing device of the user. In some example embodiments, identifications of communication mediums corresponding to the notification message and the command message are caused to be displayed concurrently with the visual representations of the notification message and the command message.

Alternative embodiments other than the embodiments discussed above are also within the scope of the present disclosure, some examples of which are also provided in the present disclosure.

Some technical effects of the system and method of the present disclosure are to enable a conversation to be conducted over multiple communication mediums for communication between humans and machines. These effects provide flexibility in technical solutions for the Internet of Things (the interconnection of uniquely identifiable embedded computing devices) and the Industrial Internet (the integration of complex physical machinery with networked sensors and software), as a human may not be available in close proximity of a machine with which he or she wants to carry out a conversation in order to provide commands with respect to operation of the machine, such as commands to perform a diagnostic operation on the machine, commands to disable a function of the machine, and commands to adjust a configuration parameter of the machine. Such technical effects help improve the efficiency of an organization by improving collaboration, enabling people and machines to use any medium of communication to continue a conversation and collaborate. In situations involving communication between machines and people, these technical effects also improve the mean time between failures and increase the reliability of the corresponding machine-based systems, as the issues will receive quick attention by expanding the mode(s) of communication for a conversation to multiple available communication mediums. Additionally, other technical effects will be apparent from this disclosure as well.

The methods or embodiments disclosed herein may be implemented as a computer system having one or more modules (e.g., hardware modules or software modules). Such modules may be executed by one or more processors of the computer system. In some embodiments, a non-transitory machine-readable storage device can store a set of instructions that, when executed by at least one processor, causes the at least one processor to perform the operations and method steps discussed within the present disclosure.

In the description below, for purposes of explanation only, specific nomenclature is set forth to provide a thorough understanding of the present disclosure. However, it will be apparent to one skilled in the art that these specific details are not required to practice the teachings of the present disclosure.

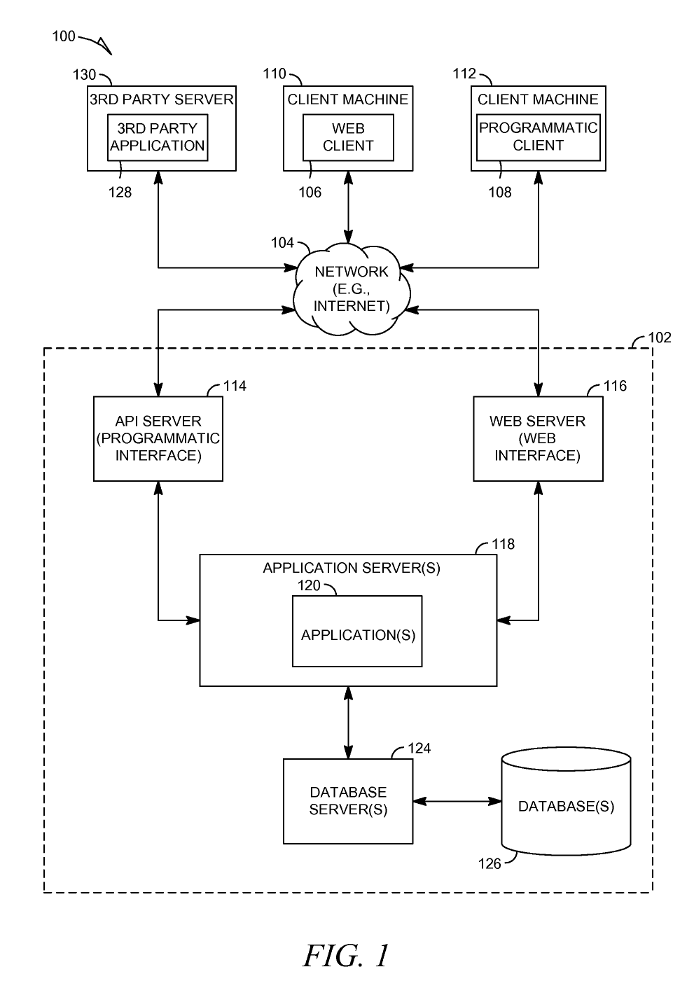

FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

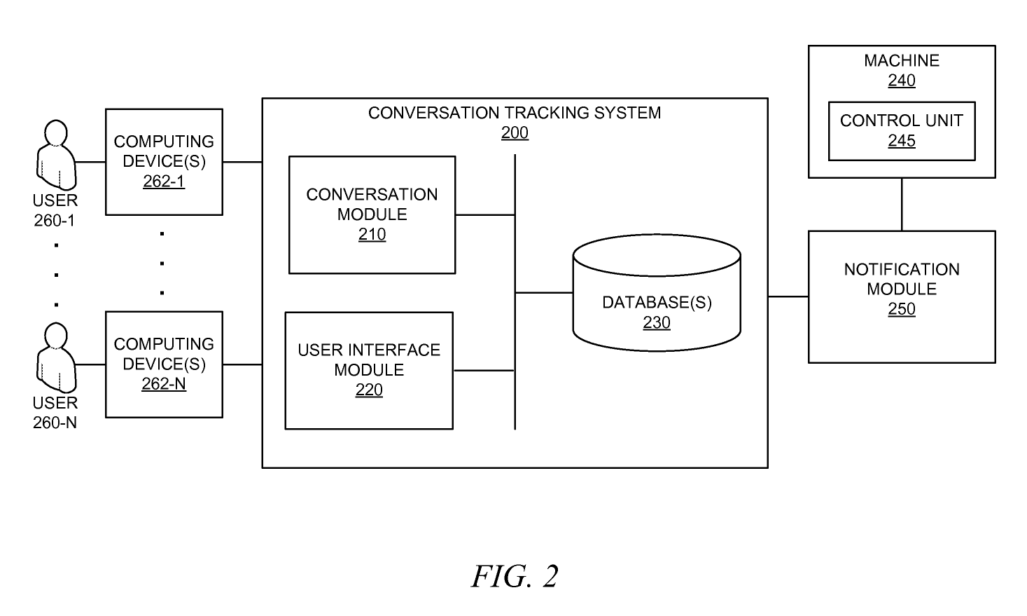

FIG. 2 is a block diagram illustrating components of a conversation tracking system 200, in accordance with some example embodiments. The conversation tracking system 200 provides a conversation service that manages one or more conversations. In some example embodiments, this conversation service not only manages the transmitting of messages over various mediums, but also listens for messages being transmitted from multiple mediums. The conversation tracking system 200 can enable the two-way exchange of messages via all supported communication mediums, as well as the tracking of the exchanges spanning multiple mediums as part of one conversation, thereby allowing unprecedented collaboration, as a user is not restricted to only one communication medium to continue a conversation.

In some example embodiments, a human user or a machine transmits a message to be sent by the conversation tracking system 200 to one or more recipients over his or her or its choice of communication medium(s). The conversation tracking system 200 can assign a unique conversation identification to the message and transmit this first message on all available communication mediums to the intended or otherwise concerned recipients. The recipients can reply to this message over the communication medium of his or her or its choice or availability. The conversation tracking system 200 can receive the reply and transmit it on all available communication mediums to the initial sender, and the conversation can continue. The conversation tracking system 200 can record these messages as part of a conversation, and can enable users to view these messages together concurrently in chronological order. The conversation tracking system 200 can also tag which communication medium was used to transmit the message and which communication medium received replies.

In some other example embodiments, a human user or a machine transmits a message to be sent by the conversation tracking system 200 to one or more recipients over his or her or its choice of communication medium. The conversation tracking system 200 can assign a unique conversation identification to the message, and can transmit the first message on only one communication medium, such as a preferred communication medium of the recipient, along with the conversation identification. The preferred communication medium can be selected based on one or more factors, such as an explicit user preference or based on a time-based policy (e.g., one preferred communication medium during the day time versus another preferred communication medium during the night time), or it could be a complex policy setting that can comprise any combination of one or more of time, preference, bandwidth, and criticality of message, as well as other factors. The recipient of the message can then use the unique conversation identification in his or her reply over any communication medium of his or her choice. The conversation tracking system 200 can receive this reply message and determine, based on the conversation identification, which conversation this message belongs to. The conversation tracking system 200 can then track that message as part of the conversation and send the reply to the sender of the initial message over his or her communication medium of choice, again including the unique conversation identification for that conversation.

In the example embodiments discussed above, the conversation tracking system 200 can achieve exchanges over multiple communication mediums within the same conversation. The conversation tracking system 200 can also tag the message with the communication medium over which it was received and store this information in a database. The conversation tracking system 200 can further include the previous messages of the same conversation as part of the message it transmits to the recipients in order to provide the context of the message within the conversation.

Further details of the conversation tracking system 200 will be discussed below.

The communication (e.g., transmission) of data between systems, modules, databases, users, devices, and machines disclosed herein can be achieved via communication over one or more networks. Accordingly, the conversation tracking system 200 can be part of a network-based system. The network may be any network that enables communication between or among systems, modules, databases, devices, and machines. Accordingly, the network may be a wired network, a wireless network (e.g., a mobile or cellular network), or any suitable combination thereof. The network may include one or more portions that constitute a private network, a public network (e.g., the Internet), or any suitable combination thereof.

In some example embodiments, the conversation tracking system 200 comprises any combination of one or more of a conversation module 210 and a user interface module 220. The conversation tracking system 200 can also comprise one or more databases 230. The conversation module 210, the user interface module 220, and the database(s) 230 can be communicatively coupled to each other, and can reside on a machine having a memory and at least one processor (not shown). These components of the conversation tracking system 200 can also reside on separate machines. In some example embodiments, the conversation module 210 and the user interface module 220 can be incorporated into the application server(s) 118 in FIG. 1 and the database(s) 230 can be incorporated into the database(s) 126 in FIG. 1. However, other configurations are also within the scope of the present disclosure.

In some example embodiments, the conversation module 210 is configured to receive an alert corresponding to a machine 240. The machine 240 can be an industrial machine comprising physical machinery configured to perform industrial operations (e.g., a windmill, a factory machine). The machine 240 can comprise a control unit 245 configured to interface with and control operational and functional components of the machine 240. In some example embodiments, the alert comprises operation information of the machine 240. The operation information can comprise information about the machine 240, including, but not limited to, an indication of a malfunction of the machine 240 and diagnostic data of the machine 240.

In some example embodiments, the alert is transmitted from a notification module 250 to the conversation module 210. Although the notification module 250 is shown in FIG. 2 as being external to the conversation tracking system 200, it is contemplated that the notification module 250 can be incorporated into the conversation tracking system 200 as an integral component of the conversation tracking system 200 (e.g., the notification module 250 can be controlled by the same organization or entity as the other components of the conversation tracking system 200). In some example embodiments, the alert can originate from the machine 240, with the machine 240 transmitting the alert to the notification module 250, which can then transmit the alert to the conversation module 210. In some other example embodiments, the alert can be generated by the notification module 250 based on the notification module 250 detecting an event or condition of the machine 240. For example, the notification module 250 can be part of a monitoring system configured to detect and analyze the status or operation of the machine 240. In response to a determination that the detected event or condition of the machine 240 indicates a situation where a user should be alerted, the notification module 250 can generate the alert and transmit it to the conversation module 210.

In some example embodiments, the conversation module 210 is further configured to determine one or more users 260 (e.g., users 260-1 to 260-N in FIG. 2) for the alert. The conversation module 210 can determine the user(s) 260 for the alert in a variety of ways. In some example embodiments, the conversation module 210 can determine the user(s) 260 for the alert based on identifying information (e.g., name, username, employee identification number, e-mail address, phone number) of the user(s) 260 in the alert transmitted to the conversation module 210. In other example embodiments, the conversation module 210 can determine the user(s) 260 based on other information included in the alert. For example, the conversation module 210 can be configured to determine the user(s) 260 for the alert based on an association between the user(s) 260 and one or more details of the alert, which can include, but are not limited to, an identification of the machine 240 corresponding to the alert, the operation information of the alert (e.g., specific types of malfunctions or diagnostic data can be associated with one or more specific users), and a timestamp of when the alert was transmitted or received (e.g., specific users can be associated with specific time ranges based on their availability to receive and respond to messages during those specific time ranges). Associations between the user(s) 260 and one or more details of the alert can be stored in the database(s) 230.

In some example embodiments, the conversation module 210 is further configured to generate a notification message comprising the operation information, and to determine one or more communication mediums with which the notification message is to be transmitted to the determined user(s) 260 for the alert. Examples of communication mediums include, but are not limited to, e-mail messaging, text messaging (e.g., short message service messaging), HTTP POST messaging, instant messaging, and VoIP messaging. Other communication mediums are also within the scope of the present disclosure.

The conversation module 210 can employ different techniques in determining the one or more communication mediums. One technique that can be employed is for the conversation module 210 to determine all of the communication mediums that are available to the user(s) 260 to which the notification message will be transmitted (e.g., all of the communication mediums to which the corresponding user has access), and to use all of those available communication mediums as the communication mediums with which to transmit the notification message. The available communication mediums for a user 260 can be determined based on associations between any such communication mediums and the user 260, which can be stored in the database(s) 230 (e.g., as part of profile information for the user).

Another technique that can be employed in determining the one or more communication mediums is for the conversation module 210 to select the one or more communication mediums from amongst a plurality of potential communication mediums based on one or more factors. Such factors can include, but are not limited to, profile information of the user 260 (e.g., a preference indicated in the user's profile), time-based information (e.g., a timestamp) corresponding to the notification message (e.g., the time of day or day of the week that the notification message is to be transmitted or that the corresponding alert was received), the operation information (e.g., an identification of a type of malfunction, an identification of a type of diagnostic data), an identification of the machine 240, a capability measurement (e.g., bandwidth) for at least one of the plurality of communication mediums, a type of computing device 262 (e.g., smartphone, tablet computer, desktop computer) corresponding to the user 260, and a detected location of the user 260 based on a detected location of a computing device 262 of the user 260 (e.g., a detected Global Positioning System location, a detected IP address).

In some example embodiments, the conversation module 210 is further configured to transmit the notification message to the user(s) 260 via the determined communication medium(s). The user(s) 260 can access the notification message via one or more corresponding computing devices 262 (e.g., computing devices 262-1 to computing devices 262-N in FIG. 2). For example, if the notification message is transmitted to a user 260 via e-mail messaging, such as to an e-mail address of the user 260, then the user 260 can access the notification message by accessing his or her e-mail account inbox using a computing device 262. If the notification message is transmitted to a user 260 via text messaging, then the user 260 can access the notification message using a computing device 262 to which text messages for the user 260 are directed. Examples of the computing devices 262 include, but are not limited to, desktop computers, laptop computers, tablet computers, smartphones, and other cell phones other than smartphones.

In some example embodiments, the conversation module 210 is further configured to store a record of the notification message in the database(s) 230 in association with a conversation identification. This conversation identification can be used by the conversation module 210 to tag messages with in order to associate the messages with the same conversation for subsequent processing, such as organization and viewing of messages of a conversation.

The user 260 can respond to the notification message by transmitting a command message via a computing device 262. In some example embodiments, the notification message can be configured by the conversation module 210 to cause the generation of a command message automatically populated with predetermined content in response to a predetermined user input corresponding to the notification message. For example, the user 260 can select a reply link or button that is displayed with or otherwise corresponds to the notification message, which can cause the generation of a command message using a predetermined template configured by the conversation module 210. The predetermined template can comprise any combination of one or more of an identification of the user 260, an identification of the machine 240, an identification of the communication medium with which the command message will be transmitted, and the corresponding conversation identification.

In some example embodiments, the command message comprises an instructional command for the machine 240, which can be entered or otherwise provided by the user 260. The predetermined template can comprise a dedicated area within which the user 260 can enter or otherwise provide the instructional command. The instructional command can comprise any set of one or more commands configured to trigger or otherwise cause an operation to be performed by the control unit 245 of the machine 240. Examples of an instructional command include, but are not limited to, a command to perform a diagnostic operation on the machine 240, a command to disable a function of the machine 240, and a command to adjust a configuration parameter of the machine 240. Other types of instructional commands are also within the scope of the present disclosure.

In some example embodiments, the user 260 can transmit the command message to the conversation module 210 via any one of the one or more communication mediums with which the notification message was transmitted to the user 260. For example, if the notification message was transmitted to the user 260 via e-mail messaging and text messaging, the user 260 can choose to reply to the notification message by transmitting a command message via one of e-mail messaging and text messaging.

In some example embodiments, the user 260 can transmit the command message to the conversation module 210 via a communication medium that was not used to transmit the notification message to the user 260. For example, if the notification message was transmitted to the user 260 via e-mail messaging, the user 260 can choose to reply to the notification message by transmitting a command message via text messaging. In such embodiments where the user 260 decides to transmit the command message to the conversation module 210 via a communication medium that was not used to transmit the notification message to the user 260, the user 260 can configure the command message to include any combination of one or more of an identification of the user 260, an identification of the machine 240, an identification of the communication medium with which the command message will be transmitted, and the corresponding conversation identification. Furthermore, the user 260 can configure the command message to include an instructional command.

In some example embodiments, the conversation module 210 is further configured to receive the command message from the user 260 via the communication medium(s) determined by the user 260, which can be different from the communication medium(s) used by the conversation module 210 to transmit the notification message to the user 260.

In some example embodiments, the conversation module 210 is further configured to transmit the command message to the control unit 245 of the machine 240 in response to or otherwise based on receiving the command message. The control unit 245 can be configured to control an operation of the machine 240 based on the instructional command of the command message.

In some example embodiments, the conversation module 210 is further configured to store a record of the command message in the database(s) 230 in association with the conversation identification.

The user interface module 220 can be configured to provide a graphical UI for the user 260 to view the exchanges within the same conversation transmitted over multiple communication mediums with appropriate tagging to identify the corresponding communication medium. Each message in a conversation can be tagged to indicate with what communication medium the exchange was conducted. The identification of the corresponding communication medium for each message can be stored by the conversation module 210 in the database(s) 230.

In some example embodiments, the user interface module 220 is configured to cause a visual representation of any messages of the same conversation (e.g., messages associated with the same conversation identification) to be displayed concurrently in association with the conversation within a user interface on a computing device of the user. The user interface module 220 can be further configured to cause identifications of communication mediums corresponding to these messages to be displayed concurrently with the visual representations of the messages.

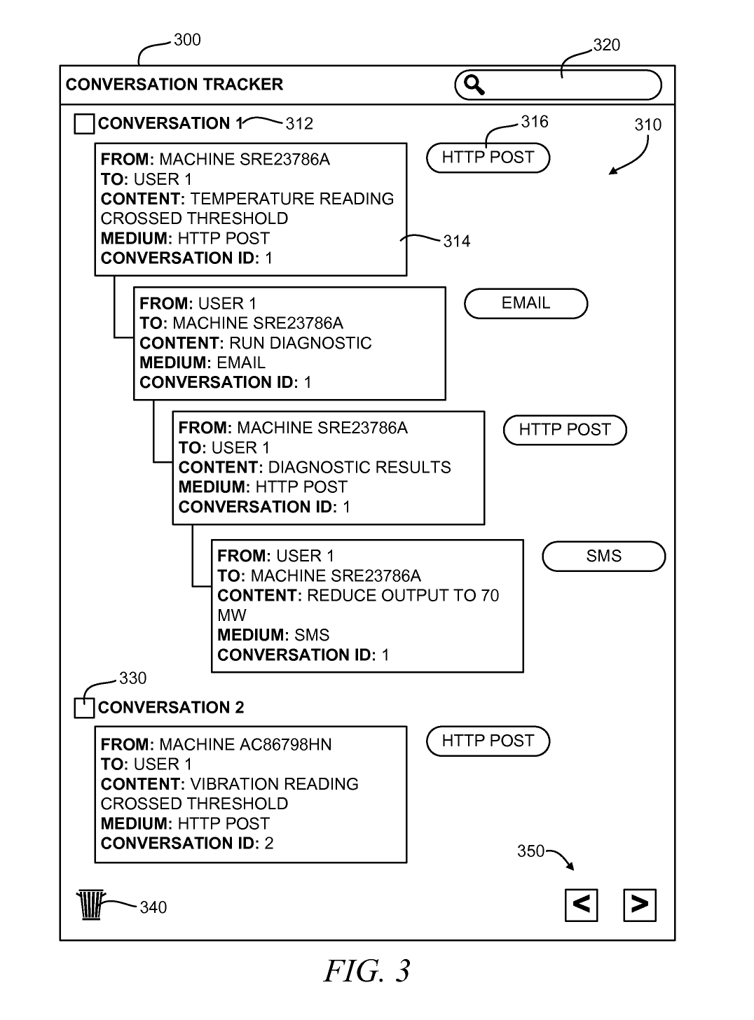

FIG. 3 illustrates a user interface 300 displaying a conversation 310, in accordance with some example embodiments. The user interface module 220 can be configured to provide the user interface 300. The conversation 310 comprises a visual representation of the messages 314 associated with the same conversation identification 312 (e.g., CONVERSATION 1). As part of the conversation 310, the user interface 300 can also display an identification 316 of the communication medium corresponding to each message along with the visual representation of the message 314 in a fashion that indicates that the identification 316 of the communication medium corresponds to the visual representation of the message 314.

In some example embodiments, the user interface module 220 is further configured to provide a query mechanism within the user interface 300 to enable a user to search for conversations or messages of conversations. For example, the user interface 300 can comprise a graphical user interface element 320, such as a text field, that is configured to enable a user to search for or sort conversations of which a record is stored in the database(s) 230. For example, a user can enter any one of a conversation identification, an identification of a machine, an identification of a user, operation information, an instructional command, and a communication medium in order to search for conversations or messages that match such a query. The results of such a query can then be displayed in the user interface 300.

In some example embodiments, the user interface 300 can be configured to enable a user to delete a conversation along with all of its corresponding messages from being displayed or from the database(s) 230. For example, a selectable checkbox 330 and a selectable trash icon 340 can be presented to enable a user to select a conversation and to delete the selected conversation (e.g., all of its associated messages) from the user interface 300 or from the database(s) 230 altogether. Navigational user interface elements, such as selectable arrows 350, can be provided to enable a user to browse to another page with more visual representations of messages 314 or conversations 310.

The example in FIG. 3 shows a conversation 310 involving interactions between one machine (SRE23786A) and one human user (USER 1) over different communication mediums (HTTP POST, EMAIL, and SMS). In some example embodiments, each message 314 in the conversation 310 is tagged by the communication medium 316 on which the message was received by the end recipient (e.g., the user 260 or the machine 240). Based on this record of the replies to a message over a different communication medium than a preceding message of the same conversation was transmitted, an organization can determine the most effective communication medium for particular types of conversations.

In addition to being configured to perform the operations disclosed herein with respect to conversations involving a human user and a machine, the components of the conversation tracking system 200 can also be configured to perform these operations with respect to conversations that additionally or alternatively involve a human user and another human user.

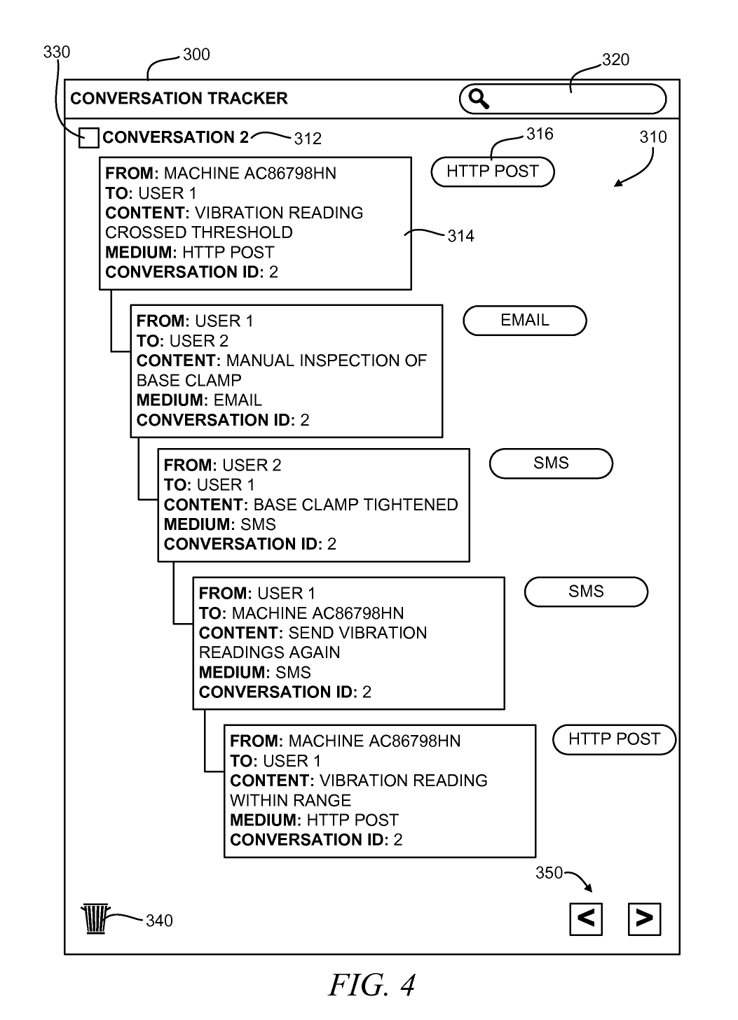

FIG. 4 illustrates the user interface 300 displaying another conversation 310, in accordance with some example embodiments. This example shows one machine (AC86798HN) and two users (USER 1 AND USER 2) communicating, using different communication mediums, within the context of a single conversation to resolve an issue.

In some example embodiments, each visual representation of a message 314 comprises a preview or summary of the corresponding message. These visual representations 314 can be selectable by the user. Accordingly, the selection of a visual representation of a message 314 by a user can cause a detailed visual representation of the message to be displayed to the user within the user interface 300. The detailed visual representation can comprise a copy of the corresponding message in the form in which it was presented to the user.

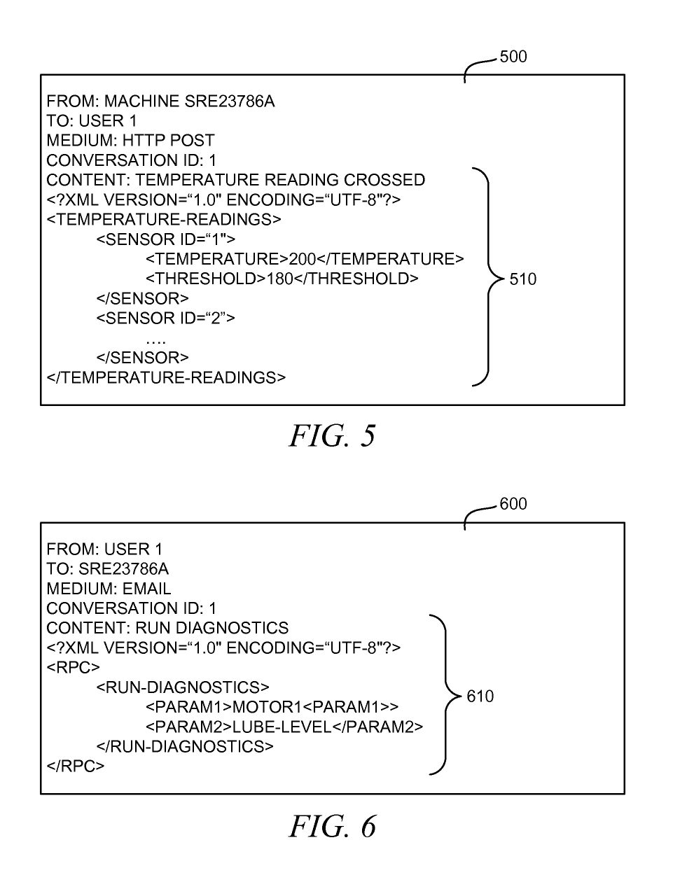

FIG. 5 illustrates a notification message 500, in accordance with some example embodiments. In some example embodiments, the notification message 500 comprises any combination of one or more of an identification of an initiator of the notification message 500 (MACHINE SRE23786A in FIG. 5), an identification of a recipient of the notification message 500 (USER 1 in FIG. 5), an identification of the communication medium with which the notification message 500 has been received (HTTP POST in FIG. 5), the conversation identification of the notification message 500 (1 in FIG. 5), and operation information 510.

FIG. 6 illustrates a command message 600, in accordance with some embodiments. In some example embodiments, the command message 600 comprises any combination of one or more of an identification of an initiator of the command message 600 (USER 1 in FIG. 6), an identification of a recipient of the command message 600 (MACHINE SRE23786A in FIG. 6), an identification of the communication medium with which the command message 600 has been received (EMAIL in FIG. 6), the conversation identification of the command message 600 (1 in FIG. 6), and one or more instructional commands 610.

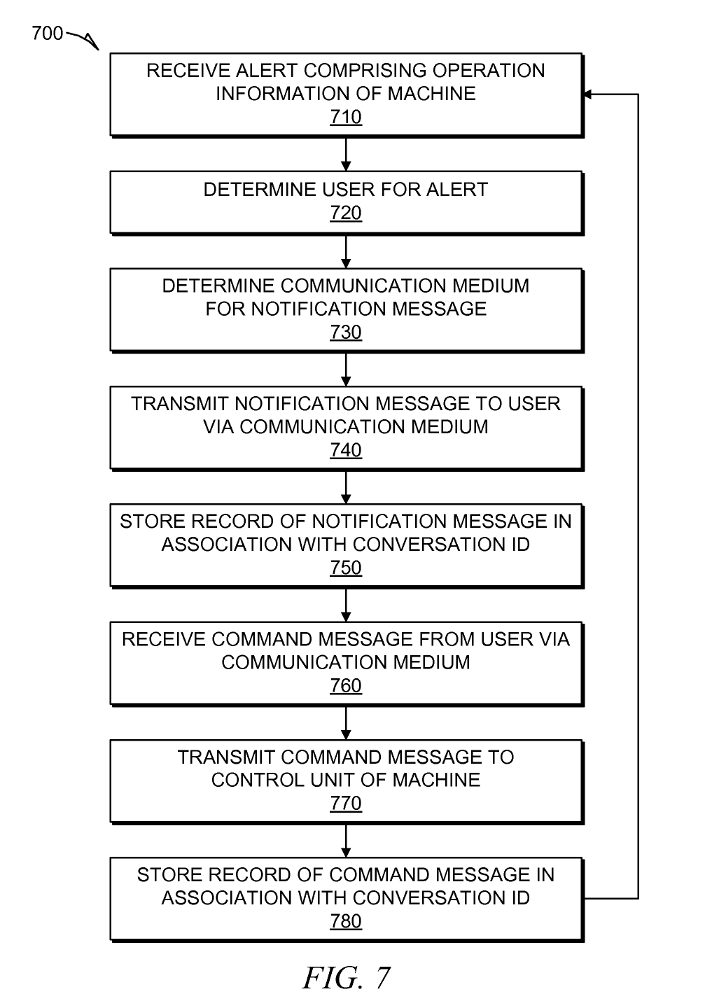

FIG. 7 is a flowchart illustrating a method 700, in accordance with some example embodiments, for tracking conversations. Method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the conversation tracking system 200 of FIG. 2, or any combination of one or more of its modules, as described above.

At operation 710, an alert is received, with the alert comprising operation information of a machine. In some example embodiments, the machine comprises an industrial machine. In some example embodiments, the operation information comprises at least one of an indication of a malfunction and diagnostic data.

At operation 720, a user is determined for the alert. In some example embodiments, the user is determined based on one or more of an identification of the machine, an identification of a type of the alert, and the operation information.

At operation 730, a first communication medium is determined for a notification message. In some example embodiments, determining the first communication medium comprises determining a plurality of communication mediums corresponding to the user, with the plurality of communication mediums comprising the first communication medium. In some example embodiments, determining the first communication medium comprises selecting the first communication medium from amongst a plurality of communication mediums based on one or more factors, such as profile information of the user, time-based information corresponding to the notification message, the operation information, an identification of the industrial machine, a capability measurement for at least one of the plurality of communication mediums, a type of device corresponding to the user, and a detected location of the user.

At operation 740, the notification message is transmitted to the user via the first communication medium, with the notification message comprising the operation information.

At operation 750, a record of the notification message is stored in a database in association with a conversation identification.

At operation 760, a command message is received from the user via a second communication medium different from the first communication medium, with the command message comprising an instructional command for the machine. In some example embodiments, the instructional command comprises at least one of a command to perform a diagnostic operation on the machine, a command to disable a function of the machine, and a command to adjust a configuration parameter of the machine. In some example embodiments, the first communication medium and the second communication medium each comprise one of e-mail messaging, text messaging, Hypertext Transfer Protocol (HTTP) POST messaging, instant messaging, and Voice over IP (VoIP) messaging.

At operation 770, the command message is transmitted to a control unit of the machine, with the control unit being configured to control an operation of the machine based on the instructional command.

At operation 780, a record of the command message is stored in the database in association with the conversation identification.

In some example embodiments, the method 700 can be repeated one or more times, with different machines, different alerts, different, users, different notification messages, different command messages, and different communication mediums corresponding to the same conversation identification.

Although in the example embodiment of FIG. 7 the machine initiates the conversation with a user, it is contemplated that a conversation of the present disclosure can be initiated by a user transmitting a message to the machine or to another user.

In some example embodiments, at any time subsequent to the record of the first notification message being stored in association with the conversation identification at operation 750, a visual representation of any or all of the messages stored in association with the conversation identification can be caused to be displayed concurrently in association with the conversation identification within a user interface on a computing device of the user or another user (e.g., as shown in FIGS. 3 and 4). In some example embodiments, identifications of communication mediums corresponding to the messages can be caused to be displayed concurrently with the visual representations of the messages (e.g., as shown in FIGS. 3 and 4).

It is contemplated that any of the other features described within the present disclosure can be incorporated into method 700.

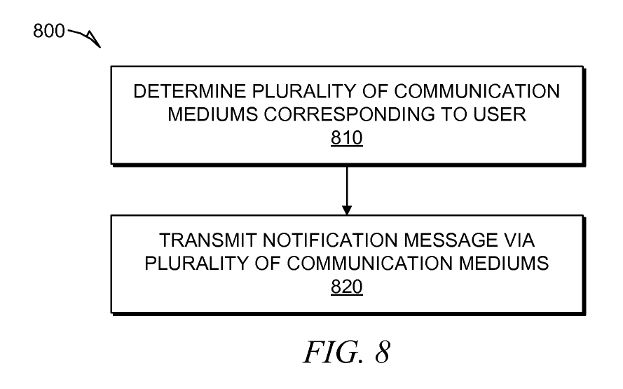

FIG. 8 is a flowchart illustrating a method 800, in accordance with some example embodiments, for determining a communication medium and transmitting a notification message. Method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the conversation tracking system 200 of FIG. 2, or any combination of one or more of its modules, as described above.

At operation 810, a plurality of communication mediums corresponding to the user is determined. In some example embodiments, referring back to method 700 of FIG. 7, the plurality of communication mediums includes the first communication medium determined at operation 730.

At operation 820, a notification message (e.g., the notification message of operation 740 in method 700 of FIG. 7) is transmitted via the plurality of communication mediums.

It is contemplated that any of the other features described within the present disclosure can be incorporated into method 800.

The following detailed use case is provided merely as an example of one possible use of the feature of the present disclosure being employed within the field of the Industrial Internet. In this use case, a windmill in a power generation station mal-functions and transmits an alert using a data driven notification service, which can be provided by the notification module 250 in FIG. 2. The notification service triggers the transmission of a corresponding message, over one selected communication medium or all possible communication mediums, to the appropriate users using the conversation module 210. The conversation module 210 assigns a unique conversation identification to this message. The user can then respond to this message (e.g., ask the machine to run some diagnostics and report the data) using e-mail messaging, as the user is at his or her desk and sees the message in the inbox. The conversation module 210 receives the reply from the user and transmits it to the windmill using custom HTTP POST (e.g., the machine can have a custom HTTP endpoint to receive commands). The windmill then runs the diagnostic command as requested by the user and responds back using the notification module 250, and this response is then forwarded to the user for further action. If the user by that time is traveling or otherwise away from his or her desk, he or she can review the diagnostic data and respond over SMS with a certain command (e.g., disable certain function, correct certain configuration parameter, or power down), which in turn is relayed to the windmill.

The technical features of the present disclosure solve the problem of a user being unable to respond to a system alert in a situation where the user is not using the right tool or medium at the point in time when the alert is raised or received. These features allow the user to respond to alerts using any medium of communication available to the user at that point. Since the features of the present disclosure enable multiple message exchanges to be tracked as part of one conversation, the user always has a context in which the communication is happening. With people working simultaneously on multiple tasks, this contextual information puts them in a better position to respond and take action.

These features enable an organization to achieve efficiencies and to reduce the mean time between failures, and to improve remote access service functionality of the costly machines, as well their reliability, availability, and serviceability. Since, in some example embodiments, each message is tagged with the communication medium over which the message was sent, an organization is enabled to run analytics to determine the most effective communication medium for a particular set of one or more conditions or factors, such as for a given time of day or for a certain user or group of users, thereby enabling the organization to achieve effective use of various mediums to address critical issues and increase the reliability of the machine-based system.

The features of the present disclosure reduce the down time of systems and machines, reduce maintenance costs by enabling critical issues to receive immediate attention, and improve productivity by increasing the operational efficiency of machine-based processes and systems. Since the conversation tracking system of the present disclosure can track and record conversations, it facilitates the use of query tools that support natural language processing to determine how the similar problems of an industrial machine were resolved previously and helps field engineers to respond quickly to such problems.

### Example Mobile Device

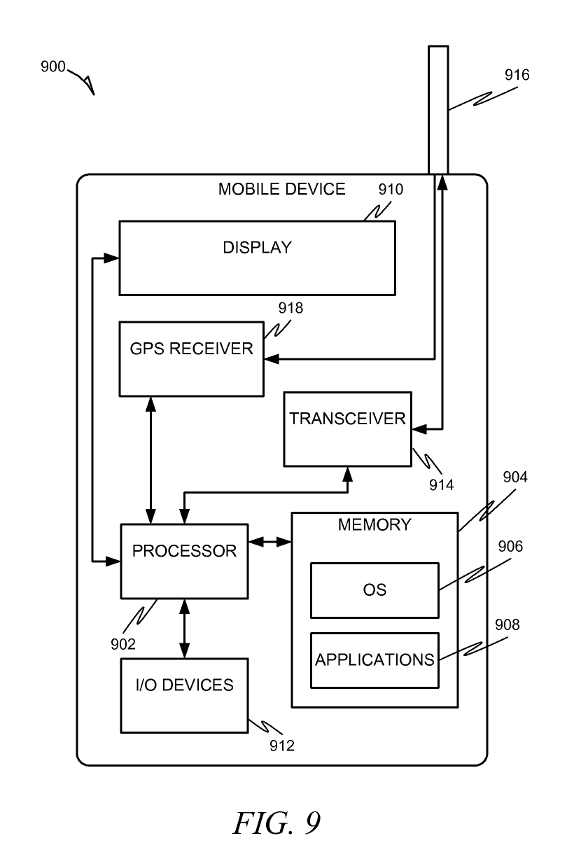

FIG. 9 is a block diagram illustrating a mobile device 900, according to an example embodiment. The mobile device 900 can include a processor 902. The processor 902 can be any of a variety of different types of commercially available processors suitable for mobile devices 900 (for example, an XScale architecture microprocessor, a Microprocessor without Interlocked Pipeline Stages (MIPS) architecture processor, or another type of processor). A memory 904, such as a random access memory (RAM), a Flash memory, or other type of memory, is typically accessible to the processor 902. The memory 904 can be adapted to store an operating system (OS) 906, as well as application programs 908, such as a mobile location enabled application that can provide LBSs to a user. The processor 902 can be coupled, either directly or via appropriate intermediary hardware, to a display 910 and to one or more input/output (I/O) devices 912, such as a keypad, a touch panel sensor, a microphone, and the like. Similarly, in some example embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

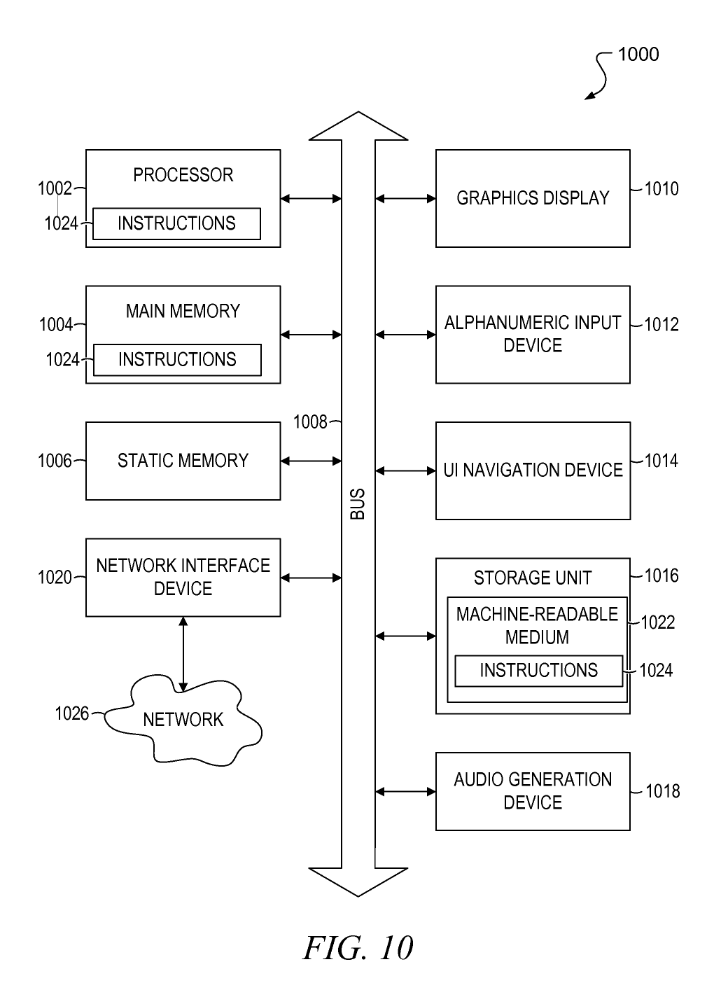

FIG. 10 is a block diagram of a machine in the example form of a computer system 1000 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a graphics or video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a storage unit (e.g., a disk drive unit) 1016, an audio or signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. The instructions 1024 may also reside, completely or at least partially, within the static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for selective gesture interaction using spatial volumes. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving an alert, the alert comprising operation information of an industrial machine;
determining a user for the alert;
determining, by a machine having a memory and at least one processor, a first communication medium for a notification message;
transmitting the notification message to the user via the first communication medium, the notification message comprising the operation information;
storing a record of the notification message in a database in association with a conversation identification;
receiving a command message from the user via a second communication medium different from the first communication medium, the command message comprising an instructional command for the industrial machine;
transmitting the command message to a control unit of the industrial machine, the control unit being configured to control an operation of the industrial machine based on the instructional command; and
storing a record of the command message in the database in association with the conversation identification.

2. The computer-implemented method of claim 1, wherein the operation information comprises at least one of an indication of a malfunction and diagnostic data.

3. The computer-implemented method of claim 1, wherein the instructional command comprises at least one of a command to perform a diagnostic operation on the industrial machine, a command to disable a function of the industrial machine, and a command to adjust a configuration parameter of the industrial machine.

4. The computer-implemented method of claim 1, wherein the first communication medium and the second communication medium each comprise one of e-mail messaging, text messaging, Hypertext Transfer Protocol (HTTP) POST messaging, instant messaging, and Voice over IP (VoIP) messaging.

5. The computer-implemented method of claim 1, wherein:
determining the first communication medium further comprises determining a plurality of communication mediums corresponding to the user, the plurality of communication mediums including the first communication medium; and
transmitting the notification message further comprises transmitting the notification message via the plurality of communication mediums.

6. The computer-implemented method of claim 1, wherein determining the first communication medium further comprises selecting the first communication medium from amongst a plurality of communication mediums based on at least one of profile information of the user, time-based information corresponding to the notification message, the operation information, an identification of the industrial machine, a capability measurement for at least one of the plurality of communication mediums, a type of device corresponding to the user, and a detected location of the user.

7. The computer-implemented method of claim 1, further comprising causing a visual representation of the notification message and a visual representation of the command message to be displayed concurrently in association with the conversation identification within a user interface on a computing device of the user.

8. The computer-implemented method of claim 7, wherein causing the visual representations of the notification message and the command message to be displayed further comprises causing identifications of communication mediums corresponding to the notification message and the command message to be displayed concurrently with the visual representations of the notification message and the command message.

9. A system comprising:
a conversation module, executable on at least one processor, configured to:
receive an alert, the alert comprising operation information of a machine;
determine a user for the alert;
determine a first communication medium for a notification message;
transmit the notification message to the user via the first communication medium, the notification message comprising the operation information;
store a record of the notification message in a database in association with a conversation identification;
receive a command message from the user via a second communication medium different from the first communication medium, the command message comprising an instructional command for the machine;
transmit the command message to a control unit of the machine, the control unit being configured to control an operation of the machine based on the instructional command; and
store a record of the command message in the database in association with the conversation identification.

10. The system of claim 9, wherein the machine comprises an industrial machine.

11. The system of claim 9, wherein the operation information comprises at least one of an indication of a malfunction and diagnostic data.

12. The system of claim 9, wherein the instructional command comprises at least one of a command to perform a diagnostic operation on the machine, a command to disable a function of the machine, and a command to adjust a configuration parameter of the machine.

13. The system of claim 9, wherein the first communication medium and the second communication medium each comprise one of e-mail messaging, text messaging, Hypertext Transfer Protocol (HTTP) POST messaging, instant messaging, and Voice over IP (VoIP) messaging.

14. The system of claim 9, wherein the conversation module is further configured to:
determine a plurality of communication mediums corresponding to the user, the plurality of communication mediums including the first communication medium; and
transmit the notification message via the plurality of communication mediums.

15. The system of claim 9, wherein the conversation module is further configured to select the first communication medium from amongst a plurality of communication mediums based on at least one of profile information of the user, time-based information corresponding to the notification message, the operation information, an identification of the industrial machine, a capability measurement for at least one of the plurality of communication mediums, a type of device corresponding to the user, and a detected location of the user.

16. The system of claim 9, further comprising a user interface module configured to cause a visual representation of the notification message and a visual representation of the command message to be displayed concurrently in association with the conversation identification within a user interface on a computing device of the user.

17. The system of claim 16, wherein the user interface module is further configured to cause identifications of communication mediums corresponding to the notification message and the command message to be displayed concurrently with the visual representations of the notification message and the command message.

18. A non-transitory machine-readable storage medium, tangibly embodying a set of instructions that, when executed by at least one processor, causes the at least one processor to perform operations comprising:
receiving an alert, the alert comprising operation information of an industrial machine;
determining a user for the alert;
determining a first communication medium for a notification message;
transmitting the notification message to the user via the first communication medium, the notification message comprising the operation information;
storing a record of the notification message in a database in association with a conversation identification;
receiving a command message from the user via a second communication medium different from the first communication medium, the command message comprising an instructional command for the industrial machine;
transmitting the command message to a control unit of the industrial machine, the control unit being configured to control an operation of the industrial machine based on the instructional command; and
storing a record of the command message in the database in association with the conversation identification.

19. The storage medium of claim 18, wherein:
the operation information comprises at least one of an indication of a malfunction and diagnostic data;
the instructional command comprises at least one of a command to perform a diagnostic operation on the industrial machine, a command to disable a function of the industrial machine, and a command to adjust a configuration parameter of the industrial machine; and
the first communication medium and the second communication medium each comprise one of e-mail messaging, text messaging, Hypertext Transfer Protocol (HTTP) POST messaging, instant messaging, and Voice over IP (VoIP) messaging.

20. The storage medium of claim 18, wherein:
determining the first communication medium further comprises determining a plurality of communication mediums corresponding to the user, the plurality of communication mediums including the first communication medium; and
transmitting the notification message further comprises transmitting the notification message via the plurality of communication mediums.
